(19) United States
(12) Patent Application Publication
(10) Pub. No.: US 2025/0162270 A1
(43) Pub. Date: May 22, 2025

(54) Method for Manufacturing a Grazing Incidence Optical Element and Optical Element Obtained Thereby

(71) Applicants: Istituto Nazionale Di Astrofisica, Roma (IT); Media Lario S.rl., Bosisio Parini (IT)

(72) Inventors: Giovanni Pareschi, Roma (IT); Rachele Millul, Roma (IT); Stefano Basso, Roma (IT); Daniele Spiga, Roma (IT); Mauro Maggioni, Bosisio Parini (IT); Giuseppe Valsecchi, Bosisio Parini (IT); Oberto Citterio, Bosisio Parini (IT); Robert Banham, Bosisio Parini (IT)

(73) Assignees: Istituto Nazionale Di Astrofisica, Roma (IT); Bosisio Parini, Bosisio Parini (IT)

(21) Appl. No.: 18/835,197

(22) PCT Filed: Feb. 2, 2023
(86) PCT No.: PCT/IB2023/050912

§ 371 Date: Aug. 1, 2024

(30) Foreign Application Priority Data
Feb. 3, 2022 (IT) 102022000001904

(51) Int. Cl. B29D 11/00; B29K 307/04; B29K 709/08; C03B 23/023; G02B 5/08; G02B 23/02

(52) U.S. Cl. CPC B29D 11/00596; C03B 23/023; G02B 5/08; G02B 23/02; B29K 2307/04; B29K 2709/08

(57) ABSTRACT

A method for manufacturing a grazing incidence optical element is provided that includes the steps of: providing a mandrel having a surface with a profile complementary to the profile of an optical surface of the optical element to be made; adhering at least one glass sheet to the mandrel to define the optical surface; and depositing a carbon fiber reinforcing material on an outer surface of the glass sheet to create a shell solidly connected to the glass sheet.

### CROSS-REFERENCE TO RELATED APPLICATIONS

This Patent Application claims priority from Italian Patent Application No. 102022000001904 filed on Feb. 3, 2022 the entire disclosure of which is incorporated herein by reference.

### TECHNICAL FIELD

The present invention relates to a method for manufacturing a grazing incidence optical element.

### BACKGROUND ART

As is known, a grazing incidence optical element comprises an optical surface which is normally a rotation surface, for example a paraboloid, a hyperboloid or an ellipsoid, sometimes combined together to obtain a double reflection system.

Typically, the grazing incidence optical elements are used for X-ray optics, as X-rays can be efficiently reflected only at angles of incidence relative to the normal to the reflecting surface close to 90° (e.g. at angles of incidence greater than 88°), unlike to what happens for visible light.

Grazing incidence optical elements with a modular structure are known, wherein the optical surface consists of a plurality of discrete modules, for example with substantially rectangular or hexagonal shape, typically made of glass. Clearly, this discretisation entails both a worsening of the optical characteristics, such as the angular resolution, and the need to integrate the plurality of the modules, which makes the production process long, expensive and difficult to manage.

Grazing incidence optical elements are also known which comprise a structure consisting of a metallic or glass shell or of monolithic glass-ceramic material, for example in nickel made for replication from mandrel by electroforming, and a continuous optical surface formed by a reflective coating, for example in gold. However, for the manufacture of such optical elements, substrates (or mandrels, if replication techniques are used) with high dimensional precision and extremely low roughness are necessary, since metallic deposition involves the replication of the roughness of the substrate or of the mandrel on the optical surface of the reflective cover. These requirements make the production process relative to monolithic grazing optics very expensive.

A purpose of the present invention is to provide an optical element that allows to overcome the above problems.

### DISCLOSURE OF THE INVENTION

The aforementioned purpose is achieved by a method as claimed in claim 1.

The present invention further relates to an optical element as claimed in claim 13 and to a mirror as claimed in claim 16.

### BRIEF DESCRIPTION OF THE DRAWINGS

For a better understanding of the present invention, a preferred embodiment is described below, by way of non-limiting example and with reference to the accompanying drawings, wherein:

FIG. 1 is a perspective view of an optical element according to the present invention;

FIG. 2 is a perspective view of a mirror according to the present invention comprising a plurality of optical elements of FIG. 1;

FIGS. 3 to 6 schematically illustrate successive steps of a method for manufacturing the optical element of FIG. 1; and

FIG. 7 schematically illustrates a plant for carrying out a step of the manufacturing method according to the invention.

### DETAILED DESCRIPTION OF THE INVENTION

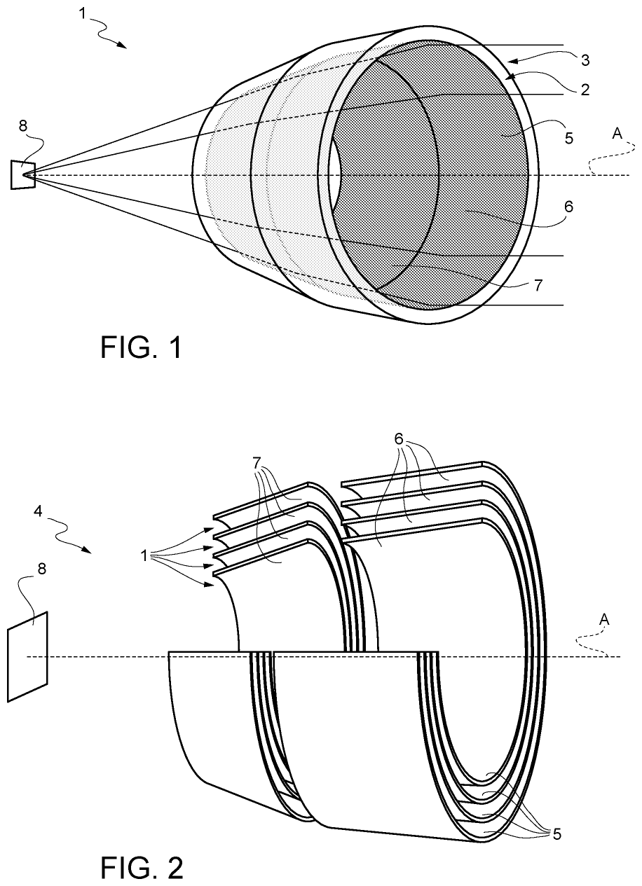

With reference to FIG. 1, there is indicated by 1 a grazing incidence optical element according to the present invention. The optical element 1 comprises a glass layer 2 and a shell 3 of reinforcing material comprising a plurality of carbon fiber layers deposited on the glass layer 2.

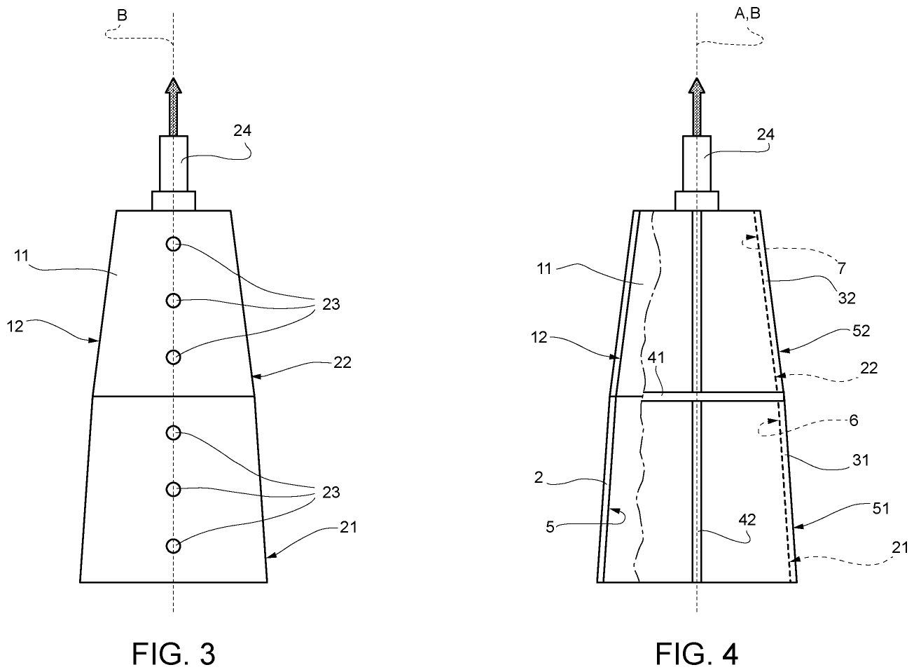

The optical element 1 can constitute (FIG. 2) a module of a mirror 4 made by integrating a plurality of optical elements 1 nested within one another.

The glass layer 2 has a thickness of less than 100 μm, preferably a thickness of 50 μm or less, and consists of one or more thin sheets, with a flexibility comparable to that of a sheet of paper. For example, SCHOTT AF32® ECO glass can be used for this purpose. The use of one or more sheets depends on the geometry of the optical surface 5 of the optical element 1, as described in detail hereinafter. The glass layer 2 inherently has a negligible roughness, of less than 0.5 nm.

In the following, without loss of generality, an optical element 1 for a type I Wolter telescope is considered having the optical surface 5 consisting of a first portion 6, which is an A-axis paraboloid, and of a second portion 7, which is a hyperboloid coaxial to the paraboloid and coupled thereto along a plane orthogonal to the axis A. Such telescope has a focal plane 8 which is reached by the incident rays after a double reflection. In particular, an incident ray is reflected from the inner surface of the first portion 6 and subsequently from the inner surface of the second portion 7, which is interposed between the first portion 6 and the focal plane 8.

The method for creating the optical element 1 comprises several steps, described in detail hereinafter.

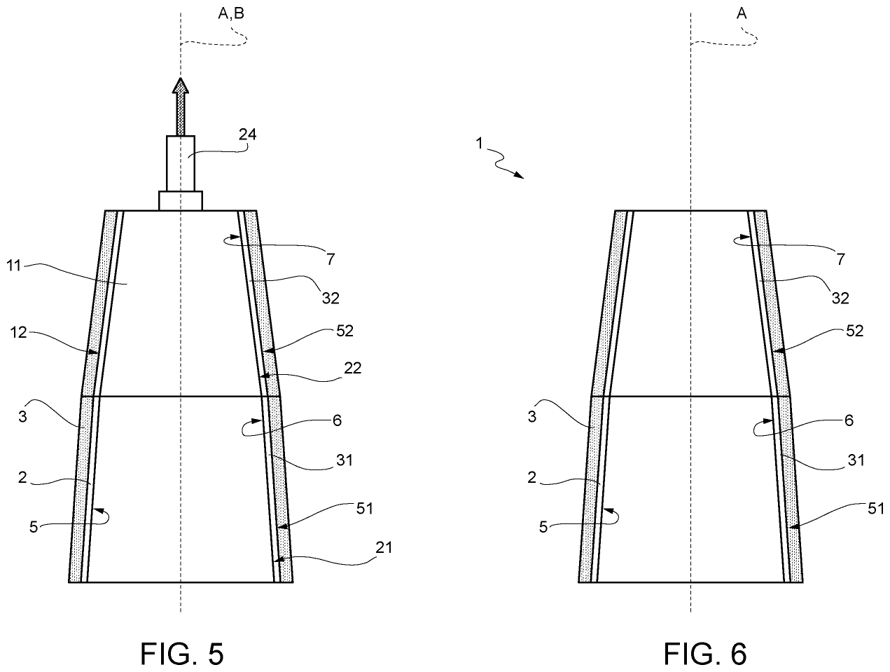

Initially (FIG. 3), a mandrel 11 having a lateral surface 12 with a profile complementary to the profile of the optical surface 5 of the optical element 1 is provided.

Therefore, the mandrel 11 is a B-axis solid, and the lateral surface 12 of the mandrel 11 comprises a first surface 21, which is a B-axis paraboloid, and a second surface 22, which is a hyperboloid coaxial to the paraboloid and matching it along a plane orthogonal to the axis B.

The mandrel 11 is machined by diamond turning, i.e. it is turned with a diamond tool, so that the lateral surface 12 is exactly equal to the desired shape of the optical surface 5. Therefore, the first surface 21 and the second surface 22 of the mandrel 11 correspond respectively to the first portion 6 and to the second portion 7 of the optical surface 5. It should be noted that in the process presented the application of a polishing step is not necessary.

The mandrel 11 internally comprises a plurality of suction ducts which are connected, at one end thereof, to respective suction holes 23 arranged along at least one generatrix of the mandrel 11 and, at an opposite end thereof, to a rotary connector 24 for connection to a vacuum source (not shown).

Subsequently (FIG. 4), in the described example relative to an optical element 1 for a type I Wolter telescope, a first glass sheet 31 is adhered to the first surface 21 of the mandrel 11 and a second glass sheet 32 is adhered to the second surface 22 of the mandrel 11.

In particular, each of the glass sheets 31, 32 is wrapped around the respective surface 21, 22 of the mandrel 11 and held in place by suction, thanks to the holes 23. Therefore, the glass sheets 31, 32 adhere to the lateral surface 12 of the mandrel 11 and replicate its shape. After the wrapping around the mandrel 11:
the first glass sheet 31 and the second glass sheet 32 match each other along a plane orthogonal to the axis A, in particular along respective adjacent circular edges, which are connected to each other via a first adhesive tape 41; and
the first glass sheet 31 and the second glass sheet 32 each have respective opposite matching edges along a generatrix of the mandrel 11, which are connected together via a second adhesive tape 42.

Subsequently (FIG. 5), a carbon fiber reinforcing material is deposited on an outer surface 51, 52 of the glass sheets 31, 32 so as to create the shell 3.

In particular, the reinforcing material is a carbon fiber reinforced polymer, also known as CFRP, which has low density, high stiffness and low coefficient of thermal expansion, which properties are necessary for creating the shell 3.

However, carbon fiber has anisotropic properties, which involve varying the elastic modulus and the coefficient of thermal expansion when the orientation of the layers changes.

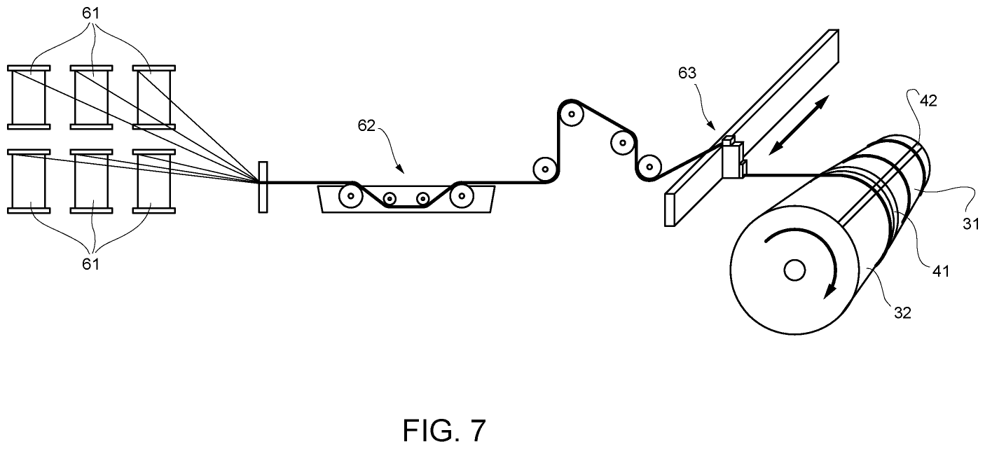

Therefore, according to a preferred embodiment of the invention, a filament winding process (FIG. 7) is carried out to create the shell 3 in CFRP, in which unidirectional carbon fibres, i.e. in the form of filaments, are impregnated with resin and wrapped on the glass sheets 31, 32 to form a distribution as isotropic as possible.

Preferably, a carbon fiber with standard elastic modulus is used. Such fiber, unwound from at least one reel 61, passes through an impregnation tank 62 to be impregnated with resin. Conveniently, the Huntsman® system is used, wherein the epoxy resin Araldite® LY5052 is used with the epoxy hardener Aradur® 5052. During the filament winding process, fiber and resin are coupled and wrapped onto the glass sheets 31, 32 via a deposition head 63 programmed so as to deposit the CFRP filaments forming successive layers until a predetermined thickness is reached. In order for the shell 3 to have isotropic properties, the filaments of one layer are deposited with a different direction than those of the successive layer.

After depositing the CFRP, the resin is cured. In particular, curing is carried out at room temperature to avoid differential thermal expansions between the CFRP and the glass sheets 31, 32.

Subsequently (FIG. 6), the optical element 1 is separated from the mandrel 11 by cooling the mandrel itself.

The optical element 1 can finally be subjected to a step of internal optical coating designed to optimise the of the mirror at the desired energy or reflectivity wavelength. The optical coating can be made by different technologies such as vacuum evaporation, deposition by sputtering process, deposition by chemical reduction of thin films. The optical coating may consist of one or more metallic or non-metallic thin films.

Upon examination of the characteristics of the optical element 1, the advantages of the present invention are evident.

In particular, the optical element 1 is monolithic. Compared to the optical elements with discretised optical surfaces, this results in an improvement in the optical characteristics, such as the angular resolution, and a reduction in time, costs and management complexity in the manufacture of the optical element 1.

The profile of the glass layer 2 has a high dimensional precision, since it is complementary to the profile of the mandrel 11 which can be made by high-precision machining, such as diamond turning. Unlike the optical elements with metallic structure (e.g. in nickel) and gold optical surface, the roughness of the lateral surface 12 of the mandrel 11, which is inherently generated by diamond turning of the mandrel 11, is not relevant for the purposes of the optical element 1, since the roughness of the glass layer 2 of the optical element 1 is negligible and the micro-roughness of the mandrel is not transferred onto the glass, due to its hardness, either by elastic deformation, or by inelastic deformation.

The characteristics of the CFRP make it suitable for the shell 3 of the optical element 1.

The filament winding process, wherein resin and unidirectional carbon fibers are used, avoiding the use of woven carbon fiber structures, allows to prevent surface irregularities of the carbon fiber from being reproduced on the optical surface 5 (print-through effect).

As an alternative to the filament winding process, it is possible to use a fiber placement process, i.e. robotic deposition of fiber in the form of a prepreg tape unwound from a reel, or by manual deposition of fiber in the form of a prepreg.

The characteristics of the production process allow to manufacture an optical element 1 that has high rigidity, thermal and mechanical stability, diameter up to 1 m and angular resolution less than 5 arcsec.

Since no polishing operations are necessary, the manufacturing time and costs of the optical element 1 are reduced.

Finally, it is clear that modifications and variations can be made to the optical element 1 without going beyond the scope of protection defined by the claims.

For example, the glass layer 2 may have a geometry defined by a conical or by a polynomial.

1. A method for manufacturing a grazing incidence optical element (1), comprising the steps of:
providing a mandrel (11) having a surface (12) with a profile complementary to the profile of an optical surface (5) of the optical element (1) to be made;
adhering at least one glass sheet (31, 32) to the mandrel (11) to define the optical surface (5); and
depositing a carbon fiber reinforcing material on an outer surface (51, 52) of the glass sheet (31, 32) to create a shell (3) solidly connected to the glass sheet (31, 32).

2. The method as claimed in claim 1, wherein the mandrel (11) is machined by diamond turning.

3. The method as claimed in claim 1, wherein the glass sheet (31, 32) has a thickness of less than 100 μm.

4. The method as claimed in claim 1, wherein the reinforcing material is a carbon fiber reinforced polymer.

5. The method as claimed in claim 1, wherein the step of adhering said at least one glass sheet (31, 32) to the mandrel (11) comprises the steps of wrapping the glass sheet (31, 32) around the mandrel (11) and holding it in place by producing a vacuum between the mandrel (11) and said at least one glass sheet (31, 32).

6. The method as claimed in claim 1, wherein the step of adhering the at least one glass sheet (31, 32) to the mandrel (11) comprises the step of applying adhesive tape (41, 42) along opposite, mutually matching edges of the glass sheet (31, 32).

7. The method as claimed in claim 1, wherein the mandrel (11) comprises at least two portions (21, 22) of different geometry matching along a plane orthogonal to an axis (B) of the mandrel (11), and the optical surface (5) is defined by at least two glass sheets (31, 32) disposed on the respective portions (21, 22) of the mandrel (11).

8. The method as claimed in claim 7, wherein the glass sheets (31, 32) are joined together via an adhesive tape (41, 42) applied to respective adjacent edges of the glass sheets (31, 32) matching along the plane orthogonal to the axis (B) of the mandrel (11).

9. The method as claimed in claim 1, wherein the reinforcing material is deposited in the form of filaments.

10. The method as claimed in claim 9, wherein the filaments are impregnated with resin before being deposited.

11. The method as claimed in claim 10, comprising a step of curing at ambient temperature.

12. The method as claimed in claim 1, comprising a step of cooling the mandrel (11) to separate the optical element (1) from the mandrel (11).

13. An optical element comprising at least one glass sheet (31, 32) and a shell (3) of carbon fiber reinforcing material solidly connected to an outer surface (51, 52) of the glass sheet (31, 32).

14. The optical element as claimed in claim 11, wherein the glass sheet (31, 32) has a thickness of less than 100 μm.

15. The optical element as claimed in claim 11, wherein the reinforcing material is CFRP (carbon fiber reinforced polymer).

16. A mirror for a telescope, comprising a plurality of optical elements (1) as claimed in claim 13, coaxial and nested within one another.
